(19) United States
(12) Patent Application Publication
(10) Pub. No.: US 2012/0023004 A1
(43) Pub. Date: Jan. 26, 2012

(54) METHOD FOR SETTLING COMMODITY TRADES

(76) Inventor: David Fife, Heber, UT (US)

(21) Appl. No.: 13/248,595

(22) Filed: Sep. 29, 2011

Related U.S. Application Data
(63) Continuation of application No. 12/017,216, filed on Jan. 21, 2008, now abandoned.
(60) Provisional application No. 60/886,023, filed on Jan. 22, 2007.
(60) Provisional application No. 60/912,211, filed on Apr. 17, 2007.

(51) Int. Cl. G06Q 40/00; G06Q 10/00

(52) U.S. Cl. 705/37; 705/7.37

(57) ABSTRACT

A third party scheduling company receives future commodity transaction data from subscriber companies and identifies transactions which are circular in nature (i.e. a series of transactions which begins and ends with the same company). The scheduling company notifies the subscriber companies when a circular transaction exists to allow these companies to settle the transaction into a purely financial obligation.

### RELATED APPLICATIONS

The present application claims the benefit of U.S. Provisional Application Ser. No. 60/886,023, filed Jan. 22, 2007, which is expressly incorporated herein by reference, and U.S. Provisional Application Ser. No. 60/912,211, field Apr. 17, 2007, which is expressly incorporated herein by reference.

### BACKGROUND OF THE INVENTION

1. The Field of the Invention

The present invention relates to scheduling and settling commodity trades. More specifically, the present invention relates to a method and system for tracking the commodity trades made between a large group of companies. The method provides for the settling or trades which are circular in nature (series of trades which can be traced to begin and end with the same party) and therefore do not need to be delivered physically.

2. State of the Art

It is common for companies to trade commodities. Companies which may not be able to meet their customer demands may purchase commodities from other producing companies. Companies which may have surplus production capacity may sell commodities to other companies who need additional production. Companies have developed businesses around the buying and selling of commodities. These companies may buy and sell the same commodity many times for a given delivery date or period.

Many commodities, including energy contracts, sell in a “forward” physical market. This means that someone can purchase a desired commodity for delivery in the future. Many commodities can be purchased for future delivery, including grains, food, cattle, animals, coffee, metals, currency, electricity, natural gas, propane, oil, lumber, etc. Many companies actively buy and sell commodities, sometimes without the intent of ever receiving the commodities.

Commodity trading will often affect the credit rating of a company, and will usually result in some risk. If company A purchases electricity from company B, company A's total credit risk associated with company B is determined from the risk of default or bankruptcy of B, the net cash receivables from B, etc. and may typically be modified daily according to changes in market conditions and prices. The same is true for the credit risk of company B. If a company is unable to meet their obligations to other companies, these other companies will need to find another source for the desired commodities, often at an increased cost. Companies are often required to maintain a sufficient amount of financial security, such as capital reserves, letters of credit, corporate guarantors, etc. to account for these varying risks. The costs of these financial securities tie up and deplete a company's available financial resources. Increasing market volatility (the speed at which price changes occur) increases the risk for future commodity transactions, thereby increasing the drain on financial resources required to mitigate that risk. Eliminating any circular transactions not only eliminates financial liability and the resulting loss in available capital, but also eliminates the time and work required to manage these transactions and the financial risk, and may increase efficiency by eliminating unnecessary transportation or delivery of the commodities.

In some situations, a company may first buy a commodity from another company and then later sell the same commodity to the company before receiving the first commodity. For Example, in January, company A may purchase 1000 barrels of oil from company B for delivery in July at $30 per barrel. In March, company A may then sell 1000 barrels of oil to company B for delivery in July at $32 per barrel. At that point, there is no need for physical delivery of the oil as the net transfer of oil is zero. Such a string of transactions where the net transfer of goods between companies is zero is referred to as a circular transaction.

As many companies engage in commodity transactions, circular transactions may be formed with multiple companies. It may occur that company A sold to company B, who sold to company C, who sold to company A. Some circular transactions may occur involving parts of sales, such as where company A sold 1000 units to company B, who sold 2000 to company C, who sold 800 to company A. A circular transaction exists with regards to 800 units. It is appreciated that that in many industries there are a large number of companies trading commodities.

Companies generally wish to evaluate the transactions which have occurred so as to identify circular transactions and settle those transactions by reducing them to a purely financial exchange. This will free up some of the companies financial resources which have been tied up in insuring against the risk of default of another company in providing or receiving commodities. It is easily appreciated that it is quite difficult to track the transactions occurring between many companies in a field of industry. As 10, 20, or more companies are involved in trading a given commodity, it can be quite difficult to determine what the net result of the trading is, including any formed or potential circular transactions which may allow reducing these transactions to financial obligations only. In some cases, as many as 30 companies can be involved in creating a single circular trading path.

Currently, companies manually evaluate their commodity transactions to find any circular transactions. Companies often view the details of future commodity transactions, such as the other party, quantity, price, etc. as confidential information until shortly before the transaction was to be performed, balancing the desire to settle circular transactions with the desire to keep information about their trades confidential. Immediately prior to the scheduled delivery month, a scheduling staff will often telephone other companies to inquire about their trades with the particular commodity and try to manually piece together circular trades. It will easily be appreciated that this is time consuming and inefficient, and may not result in the discovery of all circular transactions.

There is thus a need for providing a method of settling circular commodity trades between multiple companies. Such a method may result in lowered credit risk, increased available capital, increase in scheduling efficiency, reduction in employee workload, and the ability to hedge against credit risk to participating companies.

### SUMMARY OF THE INVENTION

It is an object of the present invention to provide an improved method for identifying circular transactions in commodity trading and for settling the same.

According to one aspect of the invention, an outside company may be used to track commodities trades and to identify and settle circular transactions. That company may receive information from various companies regarding their commodity trades. This information is preferably maintained as confidential so as to prevent the participating companies of third parties learning about a company's trades. The company may analyze the information and identify groups of commodity transactions which form a circular transaction. After identification of a circular transaction, the various transactions may be settled into purely financial transactions. The companies involved may then be notified of the change in status.

These and other aspects of the present invention are realized in a method for settling commodity transactions as shown and described in the following figure and related description.

### BRIEF DESCRIPTION OF THE DRAWINGS

Various embodiments of the present invention are shown and described in reference to the numbered drawings wherein:

FIG. 1 shows a diagram representing a number of commodity transactions between various companies for a single commodity;

FIG. 2 shows a diagram illustrating a circular commodity transaction resulting from the transactions of FIG. 1;

FIG. 3 shows another diagram representing a trading hub for a commodity;

FIG. 4 shows a diagram illustrating a number of trades occurring at the trading hub of FIG. 3;

FIG. 5 shows a diagram illustrating how the trades of FIG. 4 result in a circular transaction;

FIG. 6 shows a diagram illustrating the financial obligations after settling the circular trades of FIG. 5; and

FIG. 7 shows a system for accomplishing the settling of commodity trades according to the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

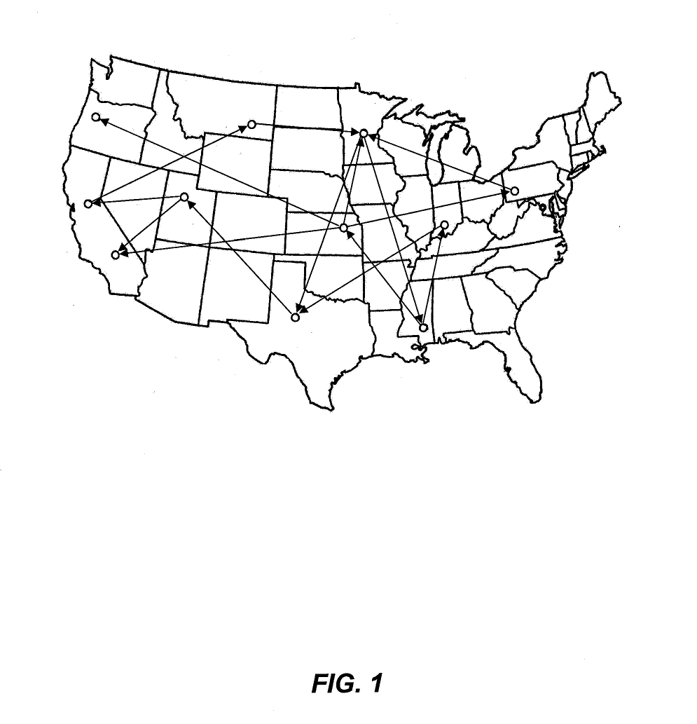

Turning now to FIG. 1, a diagram of the United States is shown which illustrates a variety of companies (designated by circles) and a variety of future commodity transactions (designated by arrows) which have occurred between the various companies. An arrow designates the transfer of goods to a particular company. Cash flow, etc. for payment for the various transactions is not shown for simplicity. It is not immediately apparent whether a circular transaction exists. However, it must be remembered that the various companies do not have access to the information shown. Each particular company has access to information regarding the transactions which they are a part of.

As the date nears for the completion of the transactions, many companies wish to determine whether any circular transactions exist to allow them to eliminate the physical transfer of goods. As discussed, scheduling personnel at the various companies may begin to call the other companies to seek transaction information and determine if a circular transaction exists. This requires a significant amount of time and work.

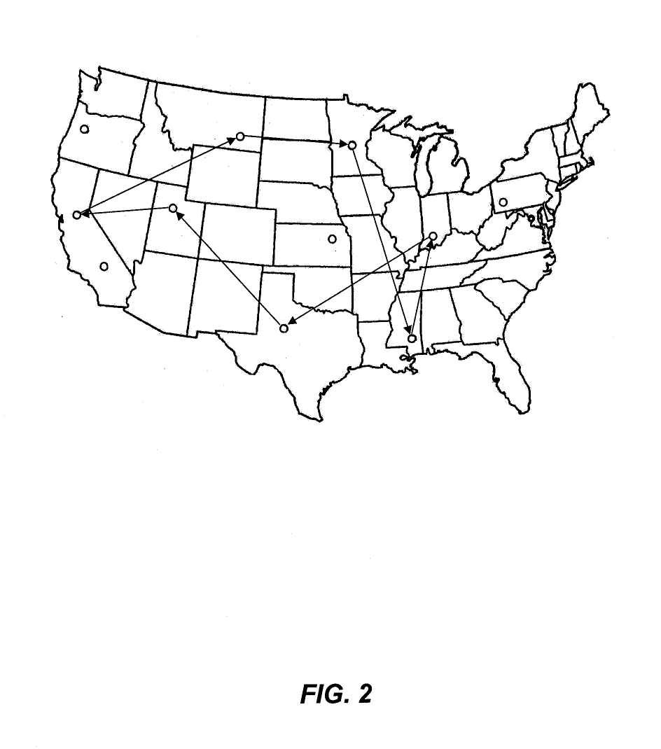

As shown in FIG. 2, a circular transaction does exist. The arrows representing individual transactions which are not part of this circular transaction have been omitted for clarity. The circular transaction allows companies to eliminate the physical transfer of the commodity and settle these transactions to purely financial transactions. Of all of the various transactions made between the companies, more than one circular transaction may exist. In fact, it is likely that numerous circular transactions will exist between the various companies. It is also possible that several circular transactions also can be combined to from one larger circular transaction.

Identifying the transactions which form a circular transaction allows the companies to settle the transaction to a purely financial transaction as has been discussed. As discussed, it is currently difficult to identify circular transactions because companies manually contact each other to identify transactions and attempt to identify a circular transaction, and companies regard their trading data as confidential and therefore will typically only share information about the most current delivery period, such as the current or pending delivery month.

According to the present invention, an independent company, referred to as the scheduling company, is established to identify circular transactions. The scheduling company will receive information about transactions from the various subscriber companies. Information regarding transactions will typically be transmitted electronically between the subscriber companies, such as through the internet, modem, etc. The scheduling company may receive information in a variety of methods. The scheduling company may log into the subscriber company's computer systems to periodically download the transaction information.

Alternatively, the subscriber companies may access the scheduling company to upload transaction information or otherwise send this information to the scheduling company. The subscriber companies may send transactional information upon the completion of a transaction, at the start or end of each day, etc. The scheduling company may also provide for manually entering transaction information, or verifying that the information has been correctly entered. Smaller companies may not be able to automatically transfer transaction data, and may desire to log onto a secure website or the like and manually enter transaction data. Customer and transaction information may be secured through the use of data encryption during transfer, secure websites, the use of digital certificates, etc.

It is anticipated that the scheduling company could service all types of commodities trading, or that several scheduling companies could be used for various different commodities. The scheduling company could receive transaction data from the various subscriber companies and sort the data according to the particular commodity and load each type of commodity into a separate database. The transaction data would typically contain a variety of data fields, such as the: commodity, contract type, quantity, unit price, delivery date, etc. The data may be uploaded in a delineated format which allows a computer system to automatically sort the data, identify relevant fields, load the data into a database, etc. Thus, as the scheduling company receives data from the subscribing companies, it may be automatically sorted and loaded into the correct database for each particular commodity.

The computer system for the scheduling company would include sufficient equipment and capacity for communication with the subscriber companies, handling and processing the transaction data, etc. As transaction data is loaded into a database, the computer system will search for circular transactions. The computer system may employ a variety of programs or algorithms to accomplish this, such as by connecting transaction strings to determine if a circular transaction can be made.

This could be done on an ongoing basis. In other words, the computer may settle physical transactions as soon as a circular transaction is formed regardless of how far out delivery is expected. In the alternative, the settling of physical transactions could be done at predetermined intervals, such as at 6 months, 3 months, and 1 month prior to scheduled delivery. The closer the settling occurs to delivery, the larger the circle will likely be and the greater the amount of physical transaction that can be settled. However, the earlier that a transaction is settled to a purely financial transaction, the greater financial savings are realized due to the need to account for the credit risks involved, as has been discussed.

When it is determined that a circular transaction exists, all parties to the circular transaction are informed of the circular transaction to allow them to adjust their credit requirements, capital resources, etc. Typically, electronic notification would be used. The type of notification and possible responses may vary according to the transaction. If transactions are to be completed quickly, such as that day or the next day, notification may be sent that the transaction is circular and the companies would proceed on that basis. If transactions are to be completed farther into the future, the companies may be notified of a potential circular transaction and may have a specified period of time, such as two or three days, to verify that the information is correct or to notify of any error and thereby stop the transaction from being treated as a circular transaction.

Once a transaction is determined to be circular, companies proceed on that basis and reduce the transactions to financial obligations only. The reduction of the transaction to a purely financial transaction may occur in several ways. According to one aspect of the invention, the companies may retain the entire financial transaction. According to another aspect of the invention, the companies may reduce the financial obligations by the largest common amount and retain the net financial obligation.

For example, if for a particular delivery period company A purchased 300 widgets from company B for $20 each, company B purchased 450 widgets from company C for $18 each, and company C purchased 200 widgets from company A for $22 each, a circular transaction exists. The circular transaction involves the 200 widgets common to each individual transaction. The present invention may settle this circular transaction in a variety of ways.

The original transactions and obligations may be represented by Table 1 as follows:

TABLE 1
Company A

| | | | |
|---|---|---|---|
| Ship: | 200 Widgets to | Company C | |
| Pay: | $6000 to | Company B | ($20 each for 300) |

Company B

| | | | |
|---|---|---|---|
| Ship: | 300 Widgets to | Company A | |
| Pay: | $8100 to | Company C | ($18 each for 450) |

Company C

| | | | |
|---|---|---|---|
| Ship: | 450 Widgets to | Company B | |
| Pay: | $4400 to | Company A | ($22 each for 200) |

In settling the circular transaction, the delivery of 200 widgets is eliminated, resulting in the obligations represented by Table 2 as follows:

TABLE 2
Company A

| | | | |
|---|---|---|---|
| Ship: | 0 Widgets to | Company C | |
| Pay: | $6000 to | Company B | ($20 each for 300) |

Company B

| | | | |
|---|---|---|---|
| Ship: | 100 Widgets to | Company A | |
| Pay: | $8100 to | Company C | ($18 each for 450) |

Company C

| | | | |
|---|---|---|---|
| Ship: | 250 Widgets to | Company B | |
| Pay: | $4400 to | Company A | ($22 each for 200) |

The financial obligations shown in Table 2 may be separated into the financial obligations for the 200 widgets common to each transaction and the financial obligations for the remaining widgets as shown in Table 3 follows:

TABLE 3
Company A

| | | | |
|---|---|---|---|
| Ship: | 0 Widgets to | Company C | |
| Pay: | $4000 to | Company B | ($20 each for 200) |
| Pay: | $2000 to | Company B | ($20 each for 100) |

Company B

| | | | |
|---|---|---|---|
| Ship: | 100 Widgets to | Company A | |
| Pay: | $3600 to | Company C | ($18 each for 200) |
| Pay: | $4500 to | Company C | ($18 each for 250) |

Company C

| | | | |
|---|---|---|---|
| Ship: | 250 Widgets to | Company B | |
| Pay: | $4400 to | Company A | ($22 each for 200) |

According to the present invention, the common financial obligation for the 200 widgets may also be eliminated, resulting in only a net financial obligation for the circular portion of the transaction. The result of this is shown in Table 4 as follows:

TABLE 4
Company A

| | | | |
|---|---|---|---|
| Ship: | 0 Widgets to | Company C | |
| Pay: | $400 to | Company B | ($2 each for 200) |
| Pay: | $2000 to | Company B | ($20 each for 100) |

Company B

| | | | |
|---|---|---|---|
| Ship: | 100 Widgets to | Company A | |
| Pay: | $0 to | Company C | ($0 each for 200) |
| Pay: | $4500 to | Company C | ($18 each for 250) |

Company C

| | | | |
|---|---|---|---|
| Ship: | 250 Widgets to | Company B | |
| Pay: | $800 to | Company A | ($4 each for 200) |

Thus, settling the circular transactions according to the present invention may involve both elimination of shipping goods and the elimination of a part of the financial obligation associated therewith to yield a net financial obligation and the remaining non-circular transactions, as shown in Table 4. Settling the financial obligations to a net financial obligation may be further advantageous in reducing the risk (and thus the credit requirements) experienced by each company. Eliminating the circular transaction of goods eliminates the risk of non-delivery, etc. and thus eliminates the market based credit requirements. Settling the circular financial obligations to the net financial obligations eliminates that portion of the risk of non-payment and thus reduces the credit risk of the companies.

Any remaining credit risk, such as the risk or default, may be eliminated through the purchase of a bankruptcy financial swap or another similar financial instrument. A bankruptcy financial swap is an assurance to pay a specified amount in the case of the bankruptcy of a debtor which is purchased from a third party financial institution. If desired, the scheduling company can provide contacts to various financial institutions to allow the subscriber companies to purchase a bankruptcy financial swap or other necessary instruments.

The use of a non-trading third party scheduling company and the methods discussed above provides several advantages over current methods of settling circular transactions. Because companies regard their commodity transactions as confidential, they are hesitant to disclose information to each other. They often limit disclosure and settling of circular trades to the current month, or even to the next day. Using an independent third party to analyze the transaction information and identify circular transactions keeps the subscriber company's information secure. No one knows who is trading with whom or what the terms of these transactions are except for the third party scheduling company, which is bound to keep this information confidential. The various subscriber companies are not able to view the information about other companies' trades. When a circular transaction is identified, only the necessary information is provided to each company to allow them to settle the transaction into a purely financial obligation.

The use of a third party scheduling company allows circular transactions to be identified both quickly and easily. Where companies are contacting each other to identify circular transactions, the analysis is performed manually which involves a large amount of work. Additionally, it is hindered by the hesitancy to discuss confidential information. The process is also limited to the period of time closely preceding the transaction delivery date, due to the desire to maintain confidentiality. The use of a third party company allows for automatic evaluation of the transaction information, but also allows for early evaluation of the information. Because transaction information is no longer shared with competitors, it is not necessary to wait until it is close to the transaction date to evaluate for circular transactions. The transaction data may be evaluated as soon as it is received by the scheduling company and entered into the proper database. Thus, circular transactions may be settled into financial obligations almost as soon as they are formed. Companies may save a significant amount of money by lowering their security obligations for nearly the entire period of time preceding the transaction.

It will be appreciated that the present invention may be used to resolve circular transactions where a part of a transaction is circular. For example, if A sells 500 units to B, who sells 800 units to C, who sells 400 units to A for a relevant time period, the transaction is circular with respect to 400 units of the commodity. Thus, the present invention may be used to notify the various companies that the transaction is circular with respect to 400 units of the commodity, and that portion of the transaction may be settled to a purely financial obligation.

The above description of various commodity trades discusses transactions resulting in shipment of a commodity between various different locations (i.e. company A shipping to company B, etc.). It will be appreciated that the various individual transactions may all occur at a single location such as a trading hub. For many different commodities, one or more locations exist which have become trading hubs for that particular commodity. A trading hub refers to a location where many companies engage in trading that particular commodity. Trading hubs may be shipping ports, manufacturing facilities, processing facilities, junctions in transmission lines or pipes, etc.

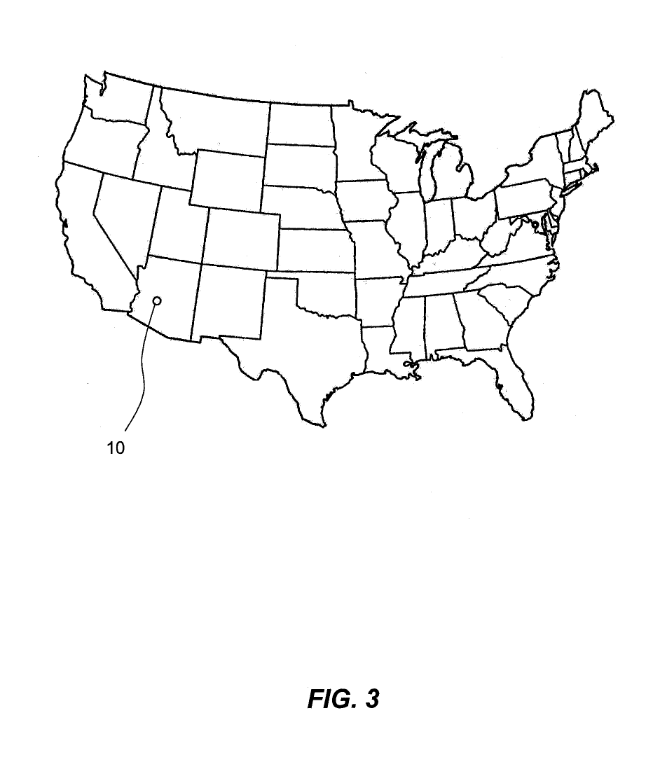

For example, the Palo Verde power generating station in Arizona may be a location of electricity trading. Companies may contract to purchase units of electricity delivered from the station or deliver units of electricity to the station. Similarly, companies may buy and sell fruit, oil, or any commodity to be picked up at or delivered to a common port. Oil or natural gas may be traded to be delivered to or picked up at a common point along a pipeline. It is thus appreciated that, for many different commodities, trading hubs may exist. FIG. 3 illustrates such a trading hub for electricity. The Palo Verde generating station 10 may be a trading hub for electricity.

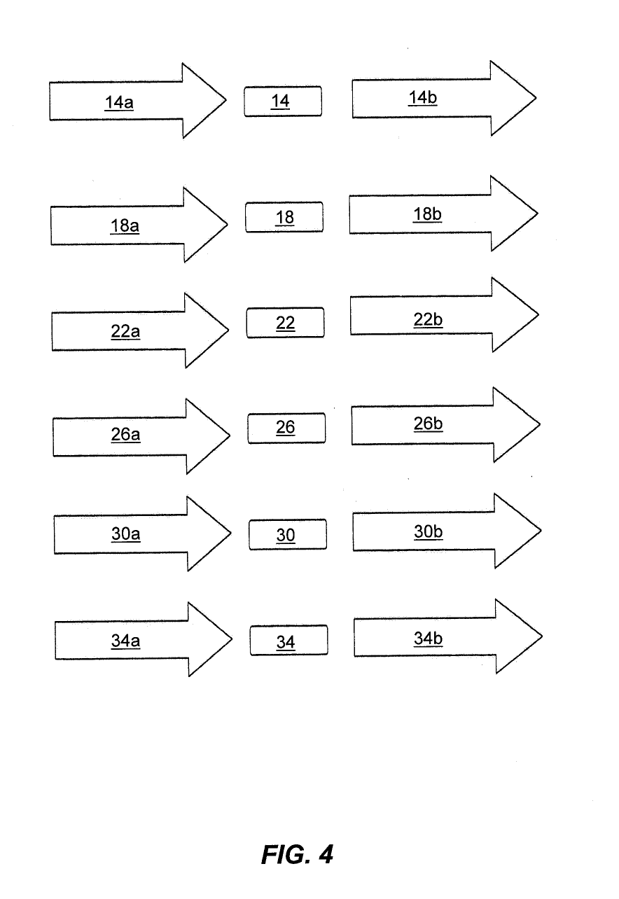

FIG. 4 illustrates a variety of different trades for electricity which may be made by different companies all for delivery at the Palo Verde station. Company A, company B, company C, company D, company E, and company F are represented by boxes 14, 18, 22, 26, 30, and 34, respectively. During a relevant trading period, company A has sold 41,600 mwh of electricity to company B for delivery at Palo Verde for $52.00/mwh, as indicated by arrow 14b. During the same trading period, the following other trades also occurred: Company B sold 41,600 mwh of electricity to company C for delivery at Palo Verde for $52.50/mwh, as indicated by arrow 18b. Company C sold 41,600 mwh of electricity to company D for delivery at Palo Verde for $53.00/mwh, as indicated by arrow 22b. Company D sold 41,600 mwh of electricity to company E for delivery at Palo Verde for $51.00/mwh, as indicated by arrow 26b. Company E sold 41,600 mwh of electricity to company F for delivery at Palo Verde for $51.25/mwh, as indicated by arrow 30b. Company F sold 41,600 mwh of electricity to company A for delivery at Palo Verde for $51.50/mwh, as indicated by arrow 34b.

As each company has bought and sold electricity, arrows 14a through 34a indicate the purchases of electricity made by the companies during the period. As noted above, company A purchased electricity from company F at indicated at 14a. Thus, 14a indicates the purchasing participation of company A in the transaction indicated at 34b. Similarly, arrow 18a indicates the purchasing participation of company B in the transaction indicated at arrow 14b, arrow 22a indicates the purchasing participation of company C in the transaction indicated at arrow 18b, arrow 18a indicates the purchasing participation of company D in the transaction indicated at arrow 22b, arrow 18a indicates the purchasing participation of company E in the transaction indicated at arrow 26b, and arrow 18a indicates the purchasing participation of company F in the transaction indicated at arrow 30b.

While the transaction indicated at 14a is the same transaction indicated at 34b, they are shown separately so that a single horizontal row indicates the transactions for which a particular company is involved. It will be appreciated that each company will only know about the trades which they are directly involved in unless that company undertakes to settle the trades into financial transactions, if possible.

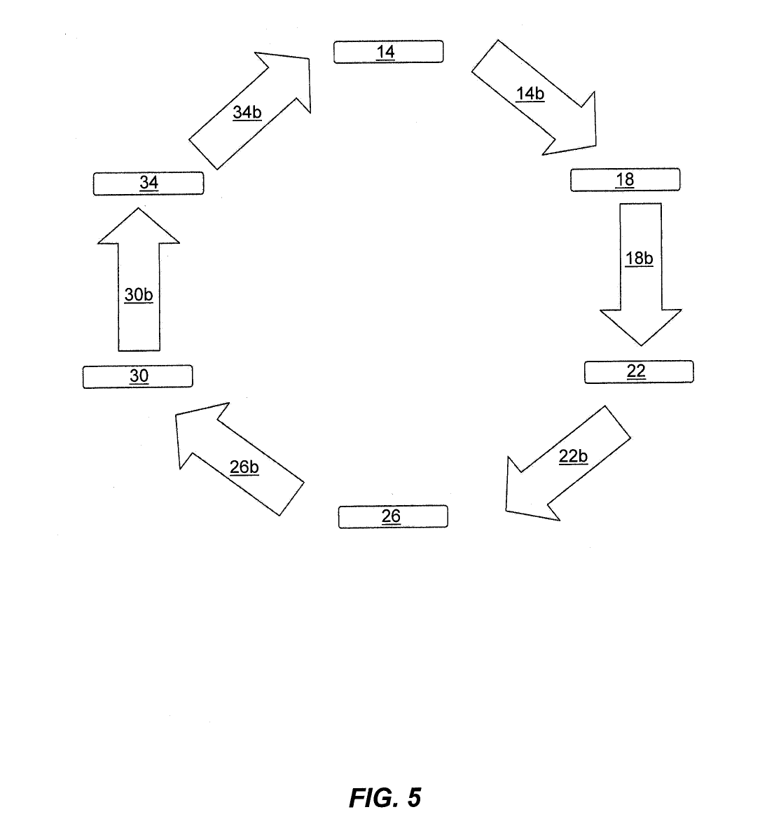

FIG. 5 illustrates the trades of FIG. 4, showing how the trades are circular in nature, with no net transfer of electricity. Again, companies A through F are indicated by boxes 14 through 34. The transactions between the companies are indicated by arrows 14b through 34b, and are the same transactions described above with respect to FIG. 4. This may be easily discovered by a third party scheduling company as discussed above. However, it may take considerable work for any one company to discover the circular transaction. It can be seen how these transactions can complete a circle of transactions, and how there is no need to physically deliver the electricity being traded.

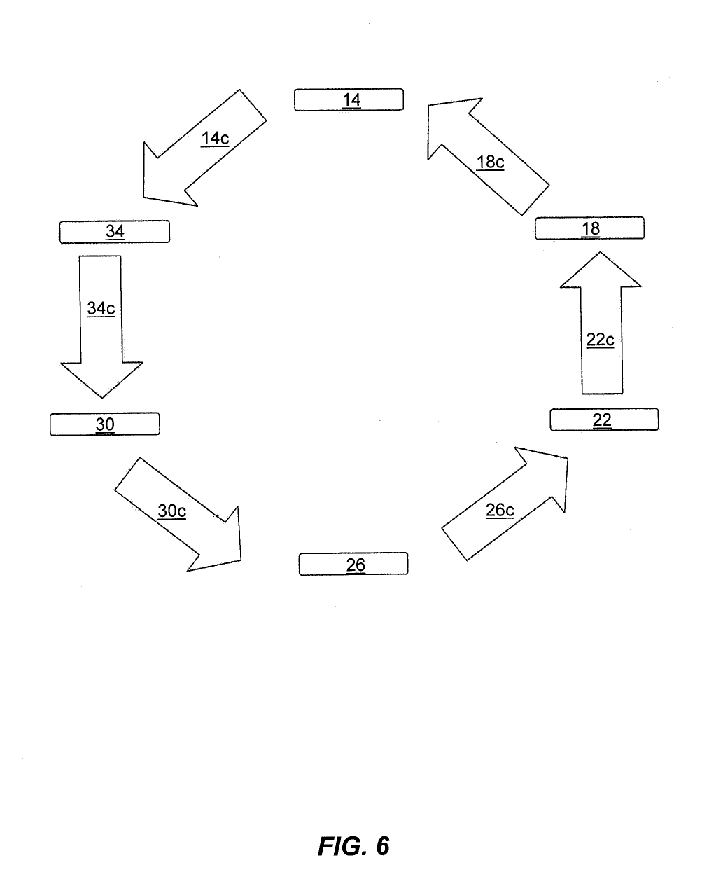

FIG. 6 shows the resulting financial transactions which remain after the electricity trades of FIG. 3 have been settled into purely financial transactions. The resulting financial transactions are that: Company A pays company F $2,142,400 (41,600 mwh at 51.50/mwh as described above), indicated by arrow 14c. Similarly, company B pays company A $2,163,200 as indicated by arrow 18c, company C pays company B $2,184,000 as indicated by arrow 22c, company D pays company C 2,204,800 as indicated by arrow 26c, company E pays company D 2,121,600 as indicated by arrow 30c, and company F pays company E 2,132,000 as indicated by arrow 34c. It will be appreciated that settling the transactions into financial transactions is beneficial to the companies. These transactions no longer require adjustments to the credit requirements of the companies based on market price movement due to the fact that the transactions no longer have physical delivery components and represent only financial obligations.

In viewing FIGS. 3-6, it is appreciated that the methods of settling commodity trades to financial obligations for a central trading hub are quite similar to the methods discussed above with respect to the non-centralized trading shown in FIGS. 1-2, and the discussion of the methods, advantages, etc. of the present invention thus apply to all of the figures presented herein.

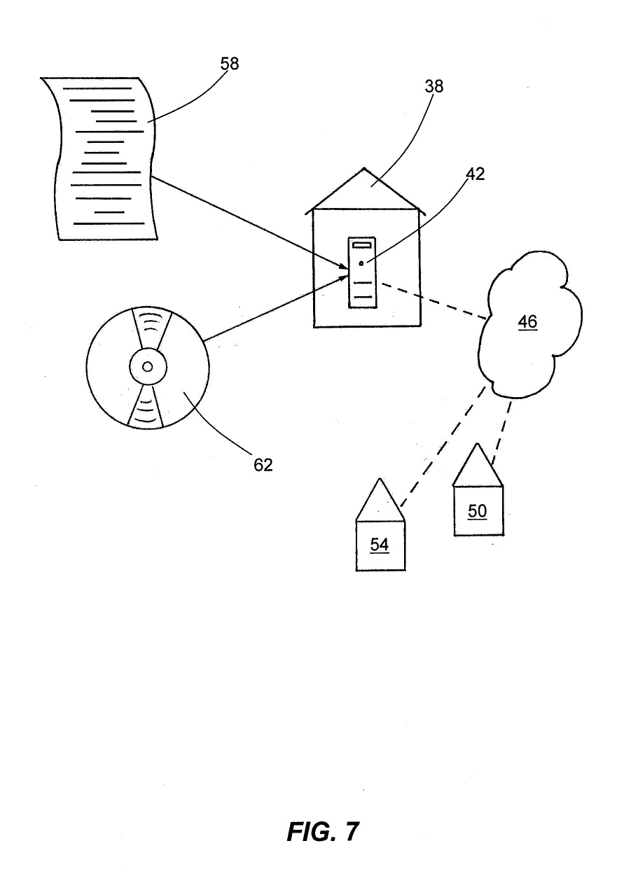

Turning now to FIG. 7, a diagram of a system for implementing the above methods is shown. Typically, a company 38 settles the commodity trades. The company 38 will typically use a computer 42 to settle the trades into financial transactions and to perform other tasks. The computer 42 will typically be connected via the internet 46 to client companies 50, 54, who engage in commodity trading. The internet 46 may be used via a secure connection to transmit trade information between the computer 42 and the companies 50, 54. It will be appreciated that other modes of communication may be used, but the internet is an advantageous and efficient method of transmitting the necessary information. The commodity trade information as described above is stored in the computer 42, typically in a data base 58. The computer 42 will also contain the necessary software 62 to analyze the relevant commodity trade information, detect circular transactions, and settle the transactions as described above.

There is thus disclosed an improved method for identifying circular transactions of a commodity. It will be appreciated that numerous changes may be made to the present invention without departing from the scope of the claims.

What is claimed is:

1. A method for identifying circular transactions in commodity trades comprising:
transmitting information regarding a plurality of commodities transactions from a plurality of subscriber companies to a scheduling company;
the scheduling company loading the transaction information into at least one database;
identifying at least one circular transaction from the plurality of commodities transactions; and
the scheduling company notifying the subscriber companies involved in the at least one circular transaction of the existence of the circular transaction.

2. The method of claim 1, wherein the method further comprises transmitting information regarding a plurality of commodities transactions for a plurality of different commodities from a plurality of subscriber companies to a third party scheduling company and loading the transaction information into a plurality of databases according to the commodity such that each database of the plurality of databases consists of transactions regarding a single commodity.

3. The method of claim 1, wherein the commodity is electricity.

4. The method of claim 1, wherein the commodity is a food product.

5. The method of claim 1, wherein the commodity is steel.

6. A method for reducing commodity transactions into financial transactions comprising:
utilizing a central data base to collect commodity transaction information from a plurality of companies;
analyzing the transaction information to identify circular transactions between the plurality of companies; and
notifying companies involved in a circular transaction to convert the circular portion of the transaction into a purely financial transaction.

7. The method of claim 6, wherein the central database accesses transaction information at the plurality of companies and downloads transaction information.

8. The method of claim 6, wherein the plurality of companies send the transaction information to the central database.

9. The method of claim 6, wherein the central database is operated by a third party company that does not trade in the commodity.

10. The method of claim 6, wherein the method further comprises eliminating the delivery of goods involved in a circular transaction.

11. The method of claim 6, wherein the method further comprises reduction of the financial obligations associated with the circular transaction to net financial obligations.

12. A system for processing commodities transactions, the system comprising:
at least one computer having a computer program operating thereon, the computer program being configured to determine circular transactions from a database of commodity transactions between a number of companies;
communications means for providing commodity transaction information from a number of companies to the computer; and
communications means for informing the number of companies when the computer determines circular transactions from the database of commodity transactions between the companies.

13. The system for processing commodities transactions of claim 12, wherein the computer program is configured to identify financial transactions to be performed when circular commodity transactions are identified.

14. The system for processing commodity transactions of claim 13, wherein the computer program is configured to prevent the companies from accessing information about the transactions of other companies in which they are not involved.

15. A method for converting commodity transactions into financial transactions, the method comprising:
collecting information about a number of commodity transactions;
processing the information to determine one or more circular transactions; and
converting the commodity transaction into a financial transaction by communicating to a number of companies information about commodities which do not need to be transferred and a net amount of money which needs to be transferred.

16. The method according to claim 15, wherein the method comprising collecting information about at least one energy commodity.

17. The method according to claim 15, wherein the method comprising collecting information about at least one food commodity.

18. The method according to claim 15, wherein the method comprises collecting the information about a number of commodity transactions from a number of different companies.

19. The method according to claim 18, wherein the method comprises only disclosing information about a settled commodity transaction to the companies involved in that commodity transaction.

20. The method according to claim 15, wherein the method comprises automatically uploading information about a plurality of transactions from a number of different companies.
